(19) United States
(12) Patent Application Publication
(10) Pub. No.: US 2024/0428212 A1
(43) Pub. Date: Dec. 26, 2024

(54) Systems and Methods for Commerce and Value Exchange Using Smart Ledgers Across Multiple Payment Rails and Multiple Channels

(71) Applicant: OV Loop, Inc., Woburn, MA (US)

(72) Inventors: Margaret Bouse, North Port, FL (US); William Graylin, Winchester, MA (US); Adam Finke, Sioux Falls, SD (US)

(21) Appl. No.: 18/751,769

(22) Filed: Jun. 24, 2024

Related U.S. Application Data
(60) Provisional application No. 63/522,954, filed on Jun. 23, 2023.

(51) Int. Cl. G06Q 20/10; G06Q 20/38

(52) U.S. Cl. CPC G06Q 20/10; G06Q 20/389; H04L 2209/56

(57) ABSTRACT

This document discloses systems and methods for commerce and value exchange between buyers and sellers with one user interface system that works across multiple payment rails, multiple channels, and multiple devices to facilitate more seamless and trusted interactions and transactions. A Software-as-a-Service (SaaS) financial ecosystem running in parallel to, and in some cases interacting with, traditional payment and e-commerce systems, leverages multiple payment environments using digital representations of value exchange managed and accounted for via a system of one or more Ledgers. Features include a new type of digital Wallet with associated companion cloud-based participant accounts and associated multiple payment rails or networks and methods for transactions, closed and open loop processing systems comprised of, in part, a comprehensive digital Ledger system, dynamic front end exposed via web services, multiple systems that manage users, roles, transactions, processing, and security including an automated Rules Engine and associated processes that manage system fidelity and system participation as a black box entity in the larger global commerce and banking ecosystems.

### TECHNICAL FIELD

The present disclosure relates generally to systems and methods for value exchange ecosystems (e.g., between buyers and sellers) using multiple payment rails across multiple channels and devices.

### BACKGROUND

In existing commerce environments, use of traditional payment and transactional management systems for electronic payments is often standardized by industry and often relies upon traditional payment networks with Merchant services, payment processors, card issuers, financial institutions (FI), and reconciliation of payments via payment rails primarily provided by VISA and MASTERCARD, or ACH (Automatic Clearing House) rails, RTP (Real Time Payments) rails via TCH (The Clearing House) or FedNow, or Prepaid Card rails, or Gift Card rails, Rewards Card rails, or Private Label Card rails.

### SUMMARY

This document discloses systems and methods for value exchange ecosystems (e.g., between buyers and sellers) using multiple payment rails across multiple channels and devices, via a common frontend buyer/user interface and via integrated backend smart ledgers for in-person and/or online transactions and interactions. The technology disclosed herein can yield various advantages compared to conventional commerce environments.

First, the technology disclosed herein can provide greater flexibility and lower operational costs compared to conventional commerce environments. For example, while existing rails (e.g., Visa/MC rails, sometimes referred to as “open loop rails”) provide methods for payments across physical and online channels, they do not provide the kind of merchant rewards or gift card that merchants and consumers want using alternative rails (sometimes referred to as “closed loop rails”), and they charge various fees associated with debit and credit payment credentials and use. Merchants often find themselves grappling with high transaction fees, processing charges, and even variable costs, including chargebacks, associated with traditional methods, and having to support multiple systems and methods on multiple rails at their POS for their loyalty, gift cards and financing options at their POS. The rise of digital payments has opened new avenues for businesses to streamline their transactions and reduce friction in the payment process, rewards and engagement, but even with digitization, the traditional payment rail (Visa/Mastercard) cost savings of digital processing and fraud reduction was never passed on by the traditional rails to the Merchants who continue to spend, as a percentage of sales, the same or greater fees than when the ecosystem was dominated with manual and low-efficiency computerized systems. The technology disclosed herein can increase flexibility for merchants and decrease their operational cost. Those decreased operational costs can increase profits and prevent passing on costs to consumers in the form of increased prices.

Further, person-to-person digital payments and transfers have become popular with segments of the population but are dependent upon special-purpose apps with limited scope whilst still relying on traditional institutional systems. The technology disclosed herein can decrease reliance on special-purposed apps with limited scope as well as decrease reliance on traditional institutional systems.

The technology disclosed herein can also have the advantage of increasing consumer adoption compared to the relatively slow adoption of conventional cryptocurrency technologies. The emergence of cryptocurrencies can offer businesses and customers a promise of decentralized and secure means of conducting transactions outside of traditional rails. However, consumer adoption has been slow due to use case friction, system complexity, lack of merchant acceptance, and tax laws requiring the recording of capital gains and losses with each exchange. The regulatory environment is also in flux, creating further complexity that severely limits its adoption by both merchants and consumers who are taking a “wait and see” approach for better experiences and regulatory clarity. Importantly, a distributed ledger and blockchain approach that is based upon a fundament of scarcity, has limited its ability to scale with elasticity to future on-demand requirements of digital payments across all strata of commerce both online and in-person. The technology disclosed herein can overcome some of these challenges, as described below.

Other features and advantages of the description will become apparent from the following description, and from the claims. Unless otherwise defined, the technical and scientific terms used herein have the same meaning as commonly understood by one of ordinary skill in the art to which this invention belongs.

### BRIEF DESCRIPTION OF DRAWINGS

FIG. 1 is a diagram of one embodiment of a system for the exchange of value between participants in a multi-player marketplace (both online and in-person) facilitated using a user interface and a multi-faceted ledger system, wholly contained inside of a value exchange ecosystem.

FIG. 2 is a flow diagram showing one embodiment of the intake of USD/fiat currency into a system, and the use of a smart ledger environment for the movement and management of value within the system prior to and including optional settlement with external traditional rails.

FIG. 3 is a flow diagram of one embodiment of a commerce transaction between a digital wallet user and a merchant, including optional pooling and proportioning of pre-funded cash towards an end-user's future purchase in a closed loop system where funds are intrinsically tied to a merchants' own ledger, funded by the merchant.

FIG. 4 is a flow diagram showing an off-network transaction request with batch electronic funds transfer between a central account and a merchant's bank via the Automated Clearing House network (ACH) for settlement and processing on behalf of the merchant.

FIGS. 5-6 are diagrams of example embodiments of an ecosystem for the exchange of value between participants in a multi-player marketplace.

FIG. 7 is a diagram illustrating an example of a computing environment.

### DETAILED DESCRIPTION

### Commerce System

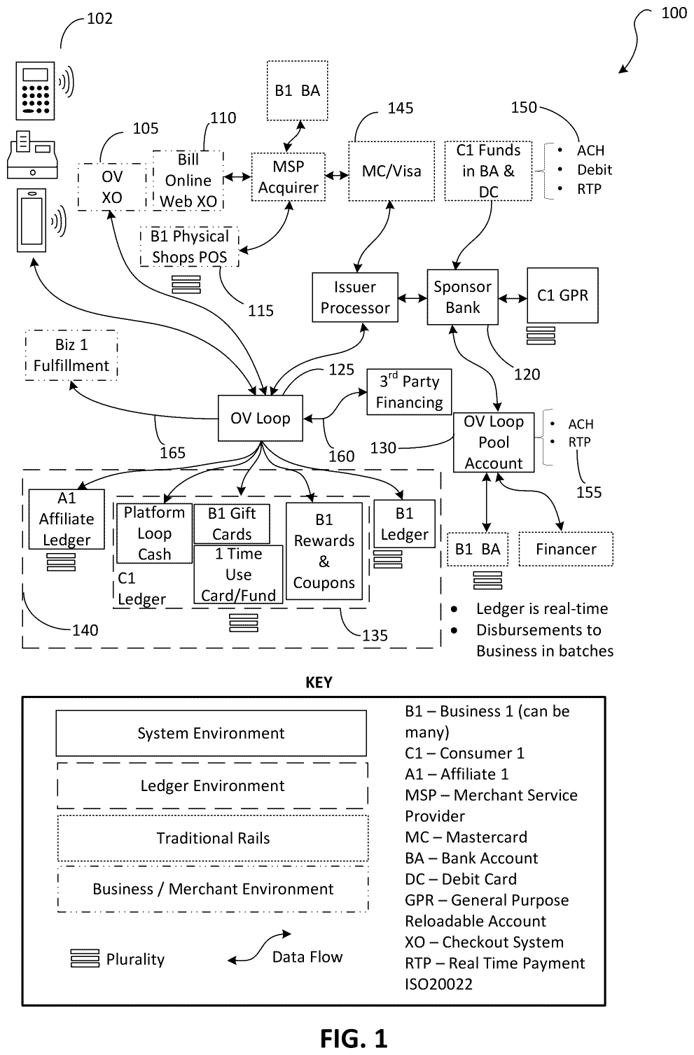

FIG. 1 is a diagram of one embodiment of a commerce system inside an ecosystem 100 for the exchange of value between participants in a multi-player marketplace (both online and in-person) facilitated using a user interface and a multi-faceted ledger system that are wholly contained inside of the ecosystem 100. The commerce system operates transactionally with and without traditional institutional systems, but with the ability to optionally transact with these systems for the eventual settlement of funds to the bank account of participants. In the embodiment illustrated in FIG. 1, the commerce system is implemented as a client/server system that includes a central server system (125) that is commonly accessed by each user type (e.g., consumers, merchants, etc.) through a plurality of client system types including but not limited to a mobile computing device, a mobile web interface, a mobile application interface, a browser web interface, a special purpose client application including but not limited to a checkout application, and a plurality of interfaces and connections to and from other devices and services both within a system environment and in external networked environments, including but not limited to payment devices that interact and transact with various payment credentials. The central server system 125, titled “OV Loop” in FIG. 1, refers to the set of software and hardware components that provide a foundation for the proposed solution described herein. The central server system 125 serves as an underlying infrastructure that enables the execution of software applications and supports their operation.

A system engine is an operational infrastructure in the displayed embodiment, whereby the system optionally enables initiating and managing transactions within a value-exchange ecosystem (e.g., the ecosystem 100), using a centralized ledger(s) to record the addition of, movement of, and exchange of stored value having been initially converted from USD/fiat currency, other fiat money, and/or digital cash/cryptocurrency. For example, as shown in FIG. 1, the centralized ledgers can be implemented in an ledger environment 140 that includes an affiliate ledger (“A1 Affiliate Ledger”), a consumer ledger 135, and a business ledger (“B1 Ledger”). These ledgers can be a repository for recording and organizing financial data, ensuring accurate and reliable tracking of income, expenses, assets and liabilities for the specific business role in the diagram. In particular, the consumer ledger 135 can be a repository for recording and organizing financial data, ensuring accurate and reliable tracking of income, expenses, assets and liabilities for a specific user/consumer. As shown in FIG. 1, the consumer ledger 135 can store financial data corresponding to various kinds of value including platform loop cash, gift cards, one-time use cards/funds, rewards, coupons, etc.

The commerce system manages value increments and their movement within an ecosystem, as well as managing resources and connections outside of a system required for the import, exchange, movement, management and optional settlement of value. For example, the central server system 125 can be used to complete payments across multiple rails including a traditional Mastercard/Visa rail (145), an ACH/Debit/Real Time Payment rail (150), an ACH/Real Time Payment rail (155) using a pool account (130), a third party financing rail (160), or a ledger fulfillment rail (165). The ledgers can be real-time and disbursements to business can be made in batches. The pool account 130 can be a bank account in a financial institution such as Sponsor Bank 120 that includes funds allocated to all platform stakeholders and can be required to cover transactions that involve other financial institutions. The Sponsor Bank 120 refers to a financial institution that enables the solution described in this document through account management and required licensing.

The central server system 125 can enable the completion of transactions via a process shown in FIG. 1 as “OV XO” 105, which involves the final step of a purchase, where the customer provides payment information and confirms their order. This can be applicable to both hardware devices or systems used for processing sales transactions in brick-and-mortar retail environments (“B1 Physical Shops POS” 115) or online transactions on website or web-based platforms (“B1 Online Web XO” 110).

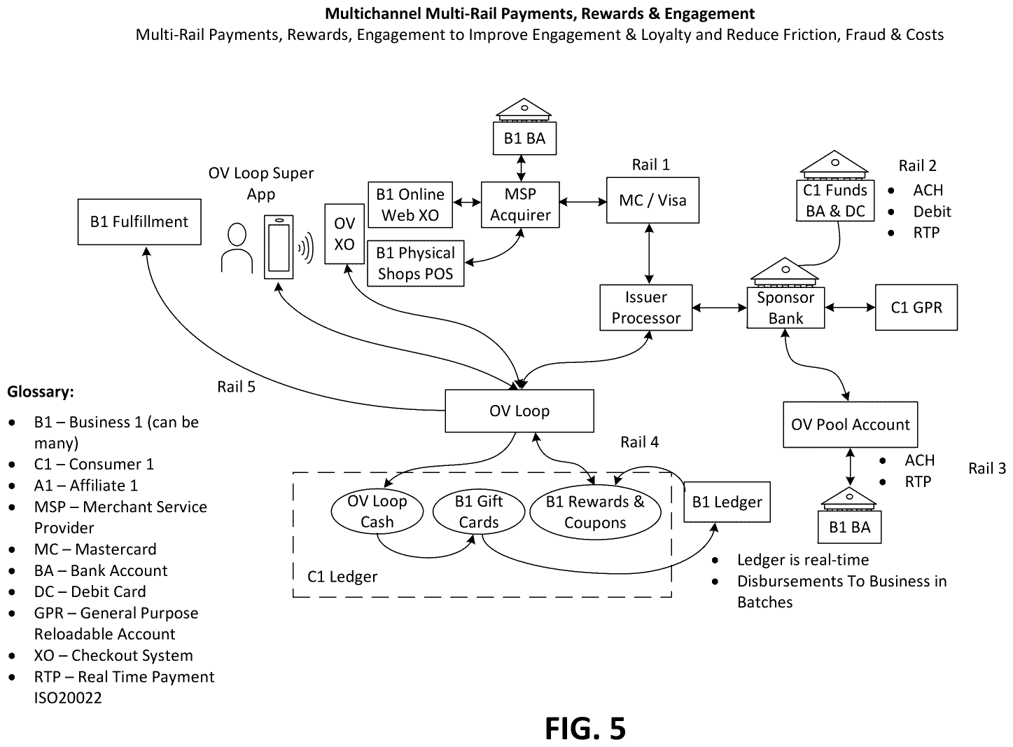

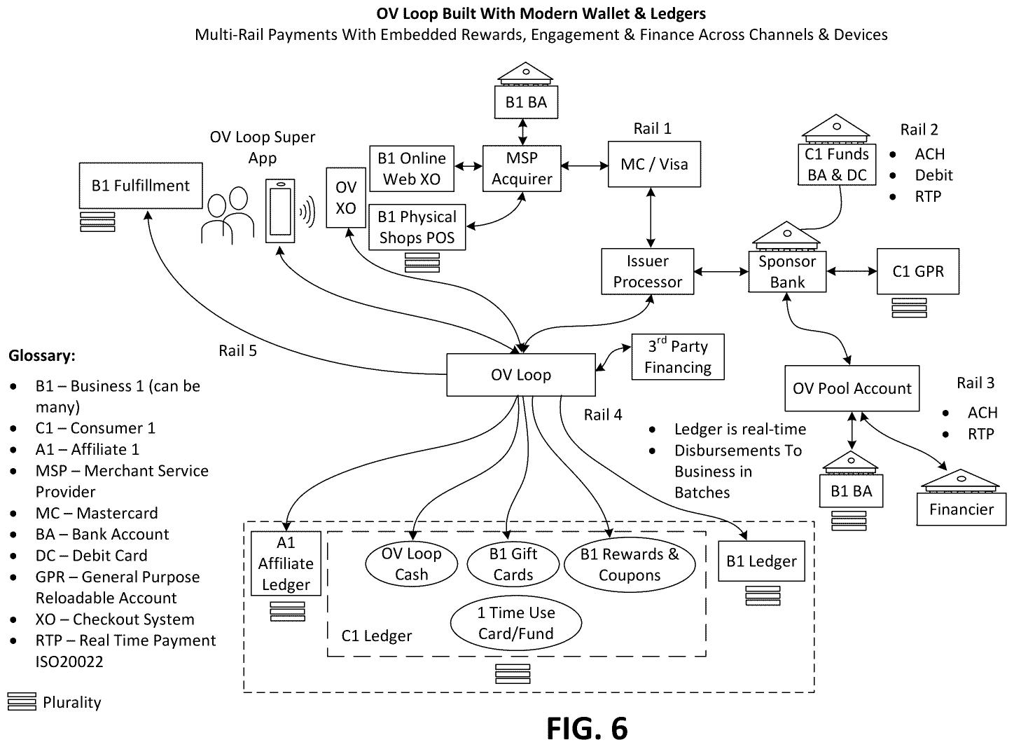

FIGS. 5-6 are diagrams of alternative example embodiments of an ecosystem for the exchange of value between participants in a multi-player marketplace and share many similarities with the ecosystem (and the commerce system) shown in FIG. 1. In FIG. 5, a single end-user (e.g., a consumer) is depicted, and additional detail is shown regarding the value flow within and between the consumer ledger (“C1 Ledger”) and the business/merchant ledger (“B1 Ledger”). Namely, FIG. 5 shows how closed loop platform value (e.g., “OV Loop Cash”) can be converted into gift card value for a particular business and then used to transfer value to the business's ledger (e.g., via the use of the gift card(s) on the business's goods and/or services). As described in further detail below, the business ledger is also able to transfer value to the consumer ledger in the form of rewards and coupons, which can be communicated back to the central server system (“OV Loop”). Referring to FIG. 6, another similar value exchange ecosystem is depicted, but includes multiple users to show how the ecosystem scales with multiple consumers and businesses participating in the ecosystem. Additional details regarding the implementation of the commerce systems described in relation to FIGS. 1, 5, and 6 are provide in further detail herein.

A potential architecture for the commerce systems described includes a four-layer approach of devices, applications, systems, and storage where storage includes the first party data as well as all ledger data described later in this document. The addition of a fourth layer above the application is for at least one envisioned embodiment that is initiated and otherwise facilitated by a networked payment device for in-person transactions between a merchant and a buyer. An end-user application layer including a digital end-user wallet and web and/or client applications executes payments and the movement and storage of value.

Another envisioned embodiment, which is independent of or combined with other embodiments includes an app or web interface for buyers, merchants, affiliates and/or other roles within the system, layered upon a services and modules layer for performing the processing, logic, business rules and movement of value amongst the ledgers, layered upon a server and database layer including the storage systems, databases, logs and ledgers for the data, currency and value management.

Importantly, while most e-commerce systems deal with a single type of value, typically a real-world fiat value, at least one variation of the proposed technology improves the state of art by supporting multiple types of digital value systems. In addition to being able to intake and settle out USD fiat currency, the system includes a digital value management module that allows end-users to transact using multiple forms of digital value and currencies, including closed-loop digital cash which is an embodiment of a managed agreement between two entities where value is exchanged, and/or an open loop digital cash stored value where value is earned and spent more broadly. In both cases, the exchange of value is based on and managed by business rules described later in this document.

In some implementations, the system prioritizes, but isn't limited to, USD/fiat currency, and fiat-currency-backed values on a ledger, plus rewards, coupons, gift cards that only work at the merchants that issue the value. These increments of value can be wholly-digital and can represent units of real-world data and property managed within compliant banking systems yet moved within the ecosystem as a unit of value, without requiring settlement on a move-by-move basis. The value is created within a closed loop ledger or rails portion of the system infrastructure and dataset, and then accounted for as it is used as value exchange in interactions both online and in-person where a ledger entries contained within the system represent actual USD or other fiat currency value for payments, exchange, conversion, and optional eventual settlement. The settlement of the value can be expanded outside of the closed loop ledger or rails and into existing open loop rails such as ACH, RTP rails into existing bank accounts, or via Visa/Mastercard rails.

These improvements present an enhanced commerce experience by integrating multiple payment rails (e.g., rails 145, 150, 155, 160, 165 described above) to facilitate integrated transfer of digital value via multiple payment rails and facilitating interactions via one common user interface (e.g., as provided by centralized server system 125 described above) across different commerce channels between different commerce entities.

At least one potential embodiment of the design is extensible to additional and/or alternate value exchange for fiat currency, rewards, coupons, gift cards, crypto currency, stable-coin, NFTs or other smart-contract-managed value systems.

The innovation is also optionally extensible to a tally or points-based system based on participant behaviors within a system or independent of other behaviors in the system but tied to external behaviors, and can be likened to the concept of a rewards points system.

A portion of the ecosystems described herein (e.g., value exchange ecosystem 100) optionally includes a marketplace where merchants can make available to end-users various products and services for sale or trade across multiple channels from physical, to web, email, digital ads, etc. The ecosystem does not require a marketplace. However, the enablement and management of value exchange between parties in the ecosystem is a meaningful improvement, in that it enables via the entries in the ledger (e.g., the ledgers implemented in the ledger environment 140) rather than, or in addition to, traditional payment rails, and can work with existing rails to facilitate transactions and rewards. In this context, end-users can buy, sell, or trade products or services or assets or stored value from a merchant and/or with each other without requiring settlement via a bank until such time as the value is to be converted to USD or other currency to be used outside of the system, and thus transferring the value via another rail to be used in a different system such as an existing bank account.

A marketplace environment can be further enhanced with the optional integration of financing for entities in the ecosystem. While financing and solutions such as Buy Now, Pay Later (BNPL) are not new, an improvement upon existing technologies is the integration of Embedded Finance for the End-User which is experienced via the end user's wallet app and their associated cloud account, and the use of a Business Rules Engine to optionally score the end-user before, during and after the use of financing and to use that disposition of trustworthiness to improve or guide their future experiences. Furthermore, the ability to leverage multiple rails to facilitate the value transfer between lender and borrower and merchant via the same common user interface allows for a better user experience by the borrower while reducing complexity of POS change by the merchant.

Any originating event between two parties who want to exchange value can kick off a transaction for processing by the ecosystem as a “Request Pay” event from a POS or a web link, be it a clickable link or button, QR code, NFC tag, or other embodiments. The management of each value type is defined by the business rules and is subject to change based on end-user actions, market dynamics, and external factors defined by the SaaS and outlined further later in this document. This improvement opens new possibilities for ledger and end-user interactions as described further in this document.

Further, specifically envisioned is at least one embodiment optionally happening inside a marketplace with an app-endpoint, and at least one embodiment optionally happening via the use of purpose-built payment devices or modified software on existing devices designed to accept the stored value in addition to or instead of traditional tender types.

In some implementations, the commerce system manages a plurality of transaction types that have different processing times including in real-time, transactions that are settled over a period of time, and transactions that hold value at rest, with or without expiry, in one or more ledgers mentioned above.

In some implementations, the end-user can loan out value from their ledger with configurable terms, managed by the Business Rules Engine, for use by other end-users.

In some implementations, the end-user sees a QR code, or link, or wireless tap request to obtain a “request payment” link on the end-user's phone at a physical or remote Point of Sale (POS), whether at a checkout, or kiosk, or automated machine, or poster or display. Upon receiving the “request payment” link, the mobile device presents an offer for action taken by the end-user, for him/her to use a payment tender established in his/her wallet to complete a transaction via the end-user's frontend user interface, with backend processing done via one or more payment rails including a closed loop payment rail, and upon a completion of such payment transaction, a fulfillment request be sent after the closed loop payment is completed, and an acknowledgement on the POS and on the frontend user interface on the End-User's mobile device.

In some implementations, the addition of peer-to-peer payments is included in the wallet app and the dependent ledger mentioned later in this document. While peer-to-peer payments are not new, the technology disclosed herein includes the ability to share value from the ledger of one end-user to another, wherein a reward value or other ledger value can be moved from one ledger account to a second ledger account for use by the recipient. An important part of this innovation not found elsewhere is that the Business Rules associated with that ledger entry, including any expiry and/or requirements for where or how to redeem are transferred along with the value.

### Ledger

One feature of the commerce systems described herein, and an improvement over current art is a comprehensive digital ledger system (e.g., ledger environment 140 containing affiliate, consumer, and business ledgers), which, in some implementations, offers transparency and accountability by recording all transactions and maintaining a historical record of the flow of all types of value within the ecosystem (e.g., ecosystem 100). While ledgers are not new, one innovation of this system is the ability, in some implementations, to capture and/or manage all transactions between participants in the ecosystem regardless of value type and characteristics. A smart ledger in the system has the option of transferring multiple values to multiple recipient accounts as part of a smart contract so as to facilitate affiliate payouts, commission payouts, transaction fee payouts, etc., as part of a group transaction for a given purchase by a buyer, based on an original smart contract.

Unlike current digital wallets such as the APPLE WALLET, GOOGLE WALLET and SAMSUNG PAY optimized for tokenized payment credentials from VISA and MASTERCARD, and also unlike current cold and hot storage crypto wallets from COINBASE, METAMASK, and others, the centralized ledger approach to the wallet described herein, as an endpoint to the Commerce System, can keep debit and credit records of any type of value, and a plurality of types of values simultaneously, and the ledger will track the increments, totals, movements, transfers, exchange and other calculations defined by rules managed in the Rules Engine. This ledger does not require bots or miners as its integrity and participation within the system is defined and controlled by the ledger mentioned prior in this document.

In at least one embodiment, a transfer of USD/fiat currency to the ledger is associated with an end-user account where it is managed by the end-user, administered by the user via the app or web services interface to be accrued and later spent or otherwise redeemed in commerce transactions. The system also optionally enables a merchant to upload USD/fiat currency to an account where it is managed as USD/fiat currency, tied to their merchant account and its associated ledger for, at a minimum, the purpose of being portioned out as pre-funded rewards to end-users' ledger accounts as stored value for commerce transactions with that same merchant. In this way, the system ensures the value is specifically earmarked for that merchant, and the earmarking is managed via the ledger that records the funds being allocated by the merchant and available to the end-user towards a future commerce transaction.

In some implementations, this environment can be based upon, include, and/or otherwise connect with a centralized or a decentralized ledger system. These ledger systems, however, would be differentiated from and improve upon cryptocurrency systems in that they are not trustless environments and do not require bots or miners for verification of transactions and instead are controlled by the Business Rules Engine described further in this document that optionally enables the ledger-based recording and management of non-crypto assets described earlier in this document and also ensures the full movement of and accounting for value entries in the ledgers within the ecosystem. The ledgers can be implemented using a traditional centralized ledger system such as a double entry ledger, or they can leverage a decentralized ledger system such as a proof of stake blockchain ledger.

It is envisioned that one of the benefits to the merchant for participating in the commerce system and ledger described herein is reduction in chargeback fees whereby end-users dispute a transaction. Unlike ecommerce transactions on existing rails, performing a transaction within the system can, in some implementations, require explicit end-user activity, authentication and consent for the purchase. This means that merchants can have confidence that once the value is transferred to their ledger, it is irrefutable and cannot be recalled by the end-user because of the non-repudiation proof of the ledger.

In at least one embodiment, the ledger manages a plurality of “pool” accounts, which are reserve accounts funded and managed by enterprise roles within the system including the System Operator as an entity, one or more merchants in the system, and/or other value exchange entities such as those described as additional embodiments further in this document. The purpose of the pool account is to pre-fund value in the system that can be pushed to other entities, including end-users, based on specific behaviors and controlled by the Business Rules Engine. An example method of operations includes transferring value from a merchant's ledger to a buyer's ledger as a reward for a purchase, or a coupon being offered to the buyer, configuring that reward or coupon as spendable solely at the merchant, assigning an expiry date, and enabling the buyer to use all or part of that reward or coupon towards a future purchase (as shown in FIG. 5 and described above). An option in the Business Rules Engine would be an expiry date assigned by the merchant, a classification of one or a plurality of a product category for redemption, a classification of one or a plurality of a product category that is excluded (e.g. a controlled substance or product), or rules regarding states, franchisees, or other ways to identify participating merchants. Alternatively, a buyer may purchase gift cards for a particular merchant, associated by transferring value from the buyer's account into the pool account with a ledger update. The gift card can then be used immediately or later to purchase goods or services.

In at least one embodiment, the Platform Operator or System Operator operates the general ledger and associated pool account across the ecosystem, with ledger entries that account for the merchant pools, end-user pools and any other funds held in the system that are fiat currencies and therefore subject to compliance within account-holder protocols and the banking system for the jurisdiction of the fiat currencies.

In some implementations, the ledger system also optionally enables the ledger to intake value as a result of a commerce transaction, and to facilitate the settlement of that value and the optional future exchange of all or part of that value back into the traditional banking system rails as a deposit into one or more bank accounts of the merchant.

The ledger system can be a centralized ledger system due to the advantages of speed and scale. However, in some implementations, a decentralized ledger system is also envisioned and can provide advantages of integration with defi solutions.

In the context of accruing, spending, saving, and trading assets, end-users can transact for products or services, assets, or currencies with merchants and other end-users. Additionally, end-users can earn stored value from merchants and organizations by participating in activities and earning rewards for their behaviors. In addition to being a value incentive, these methods could reinforce behaviors that create a growing and healthy fiscal strength for participants.

A specific optional capability is a proxy capability for an end-user to manage one or more custodial accounts with its own ledger, or an associated ledger, for the purposes of managing assets for a person or entity that is not capable of legal consent, including a child, dependent adult or other entity where the end-user has proxy rights or agent rights on behalf of another legal entity.

Also envisioned is a scenario where an end-user represents a commercial business or organization wherein the user acts on behalf of a legal entity beyond their own personal interests and assets. A few examples of this scenario is a trustee managing the ledger for a beneficiary, a comptroller managing a ledger tied to a business asset account, and a wealth manager and broker managing a ledger for a client.

Also envisioned is an embodiment scenario where all or a portion of any pool account includes value pre-funded for are transferable to affiliates that perform functions on behalf of the merchant or System Operator, including but not limited to incentives for bringing merchants and end-users into the ecosystem that execute transactions. These affiliations require agreements that are managed as part of the Business Rules Engine, and one or more embodiments are envisioned that include the use of smart contracts in a central or decentralized environment to facilitate the configurations and execution of terms of the contracts, including but not limited to the transfer of value from one entity to the other based on that configuration and its terms.

Regardless of use case, transactions can be recorded in a digital ledger, providing a verifiable record of all (or close to all) economic activities within the ledger. The ledger tracks the type and amount of value used in each transaction, the parties involved, and the nature of the transaction and any configurations specific to that ledger entry including but not limited to rules applied by the Rules Engine (e.g., where the value is spent, any expiry dates, geographic constraints, timing constraints or other trade or compliance protocols necessary depending upon the value class).

In at least one embodiment, the ledger environment 140 implements a central ledger and in another embodiment, the ledger environment 140 implements in whole or in part a distributed ledger system. The improvements of the ledger approach include, but are not limited to the authorized movement of money, value or other currencies or tender types within the ledger or from one ledger to another without requiring further processing by payment processors or traditional rails, saving the participants within a system the transactional fees charged by traditional payment processors. Additional improvements include, but are not limited to, a merchant's ability to pool this value in their own ledger, and to authorize movement of portions of that value to be moved into a ledger of users for the purposes of incentives, rewards or other use cases. In each instance, the system applies business rules such as approved uses, expiry etc., manages the movement of value amongst ledgers between participants in the ecosystem, assigns that value a purpose or scope, logs elements of the transactions, and ensures the financial integrity of the system.

In at least one embodiment, the system facilitates the use of open loop digital cash, or value from another ledger, within a digital ledger environment or in an external ledger environment, for cross-ledger exchange of value. This encourages interactions between different commerce environments and optionally enables more diverse ledger experiences. The use, trade, and storage of open loop digital cash within a digital ledger follow similar rules to those of closed loop digital cash.

Wallet Account with App and/or Web Interface

One of the improvements and key components of this system is a multi-channel, multi-device, and multi-currency-capable digital wallet system, designed to store, manage, and transact various types of digital currencies and stored value systems, providing a secure and versatile medium for entities to interact economically within the ecosystem (e.g., ecosystem 100). This is the primary way most users will interact with others in the ecosystem and the primary way they will manage their ledger via a mobile application (wallet app) on a mobile device regardless of operating system due to ease of use, and the user will optionally have access through a web services interface. In some implementations, the digital wallet app can be implemented as part of (or in communication with) the central server system 125 described in relation to FIG. 1.

Accounts are established for multiple role types within the ecosystem including but not limited to banks, lenders, merchants, buyers, users, affiliates, resellers, and each role is managed by configurable business rules, workflows, and user account choices. Each role in the ecosystem is assigned a unique ledger account which functions as a double-entry system. The use of a ledger system independent of the traditional payment rails optionally enables a double-entry system of debits and credits where value is quantified, recorded, moved, shared, partitioned or otherwise recorded in whole or in part, and balanced and/or reconciled for integrity for any and all entities in the ecosystem. These records of debits and credits are initiated by the users of the system and/or based upon their transactions and behaviors in person or online whilst interacting with the ecosystem. The resulting entries are managed by the system to be compliant with the rules of their roles and the system, and happen without the need to move the money until invoking a process for reconciliation and settlement of one or more ledger accounts. Additionally, once reconciliation and settlement has occurred, value stored in the ledgers is further used according to the rules of the system, including but not limited to further exchanges of value, such as via a commerce transaction, conversion back into USD or other fiat currencies of the original currency type, conversion to a different currency type, and/or deposit into one or more external traditional banking accounts or third-party wallets.

The system provides end-user features and controls via a custom view where the end-user can see their available currencies (closed loop digital cash, open loop digital cash, fiat value, and any value system not elsewhere classified etc.), products or services owned, current score, transaction history, and notifications. End-users can further customize their user profiles, notification preferences, and other ledger settings. These controls are available via a web interface, the wallet app, or via other systems that may provide access to or be a proxy to the cloud version of the account.

In-person and online transactions: The technology disclosed herein details a sophisticated software-as-a-service (SaaS) system, providing a complex environment supporting both in-person and online transactions where there is an exchange of value within a closed ecosystem, facilitated through the use of one or more ledgers for managing multiple forms and increments of digital currencies, including system-specific digital currencies and digitized real-world fiat currencies. The innovative system architecture seamlessly integrates several modules, each performing specific functions important for maintaining the economic exchange of value with integrity and surety.

Devices: In at least one embodiment, the technology disclosed herein can be implemented via the use of purpose-built payment devices (but not required) or modified software on existing devices.

### Business Rules Management

At times (e.g., all times, substantially all times, more than half the time, etc.), and with detailed logging and logic/processing, the commerce system initiates, manages and records the storage and movement of value with multiple ordered steps within the ecosystem itself and, depending on the use case, leveraging none, one, or more than one of these connections, ledgers, processes, transfers, reconciliations and the exchange of value from and into fiat/digital currency. It also manages the connectivity between end-users and each of the entities involved to perform a function. It also manages, and optionally enables the external management of, merchant and financial institution participation in the ecosystem on behalf of the end-users and other merchants and affiliates. The commerce system then optionally enables the end-user to perform transactions with the merchants that are functionally similar to commerce transactions, but using the value from the end-user's ledger push transferred to the merchant's ledger instead of pulling funds from a debit account or processing a credit transaction. Additionally, the system manages the business rules associated with the storage and movement of value and compliance with industry requirements, in addition to custom business rules defined by the purpose of the system including but not limited to the definition and management of where, how and when value is exchanged by the parties, including but not limited to a portion or all of the value being spendable at one or more specific merchants as described above. This good funds model using secure digital wallet with authenticated push transfer of funds from end-user ledger to merchant ledger means there is a non-repudiated transaction with no chargebacks.

The technology disclosed herein represents a value exchange ecosystem that can run independently of, or alongside, traditional SaaS commerce ecosystems that use these traditional payment rails. For example, the technology disclosed herein can include one or more centralized or decentralized ledgers to record the addition of, movement of, and exchange of stored value having been initially converted from USD/fiat currency, other fiat money, and/or digital cash and/or one or more cryptocurrencies or other smart-contract managed asset(s).

Regulatory Mechanisms: In at least one potential embodiment, a system can simulate regulatory mechanisms similar to real-world economies. An automated governing body embodied in the Business Rules Engine can adjust the ledger rules and economics, maintain balance, enforce regulations, and manage interactions between different currencies.

### Logic

Management systems with business rules and logic handle sales, transfers or settlements, and record, log and track the debits and credits and changing balances. It is designed to simulate an in-system governing body and provide the records required for auditing and controls (or at least a portion of the required records). It monitors economic activity, manages the economic parameters of the system, and enforces regulations, akin to regulatory agencies in real-world economies. Further, administrative systems manage account set up, identity authentication, and enable on a role-specific basis the ability of end-users to configure, manage and control their account and associated assets and data within the ecosystem. While the use of artificial intelligence is not required, it is specifically envisioned that combination of machine learning and/or artificial intelligence (AI) and/or predictive modules can provide significant benefits in the management of the system relative to identifying potential fraud, enhancing analytics and predicting the elasticity of the platform and its resources. The system further promotes the development of fiscal management behaviors through a ledger and scoring mechanisms described further in this document.

### Networks and Outside Sources

Connections to the commerce system include connections to outside intermediaries that 1) manage the process of identity proofing of end users before a ledger can accept USD/fiat currency, 2) the process of ACH transfers or RTP (ISO20022) transfers at volume into the pool or end-user ledger accounts, 3) financial institutions for the importing and exchange of money and for the storage, recording and management of cash-equivalent value in a pool account that is a) processed both in real time and in b) batches, and 4) at least one financial institution that will hold and manage the pool account for the system-managed ledger of the funds in the pool with one or more system-managed ledger accounts that track the debits and credits for each end-user, each merchant, the ecosystem management as a centralized entity and clearinghouse. Additionally, the system manages the connections with a plurality of outside financial institutions which includes one or more financial institutions on behalf of the ecosystem itself, each financial institution that is used by merchants in the ecosystem, and each financial institution(s) that are authorized by the end-users to be tied to their account (which can be more than one per end-user.)

### Scoring

An envisioned aspect of the proposed technology is a novel scoring engine. Unlike traditional e-commerce systems, this ledger includes a scoring mechanism that evaluates end-users' monetary management behaviors, integrity, authenticity and overall ledger performance. This adds a competitive element and provides end-users with another way to increase the ledger, beyond simply accumulating the most wealth. In at least one potential embodiment, a system includes a scoring module that awards points to end-users based on their monetary management behaviors and overall ledger performance including purchases, value exchange and the use of embedded finance discussed earlier in this document. The scoring mechanism considers factors such as the end-user's wealth accumulation, spending habits, transacting activities, and merchant configuration portfolio. End-users can increase their score via responsible and effective use of the system and their assets within it. This scoring system evaluates entities' financial management integrity, skills, behaviors, and overall economic performance within the system, creating a way to measure and report on trustworthiness and fiscal performance while also creating an index from which decisions is automated and made within the system logic and management systems including optional AI systems.

This system could help end-users develop behaviors in stored value management, strategic thinking, negotiation, and other financial concepts through ledger. The end-user can also volunteer his/her own scores to financial institutions (FIs) to request financing or loans, which allows the FI to consider the score, among other information and scoring that the FI uses to provide such financing and loans to the end-user. Such scoring can also be applied to merchants in the system to determine the credibility, integrity, and authenticity of the merchant. Additional merchant scoring may be added by allowing end-users or other parties in the ecosystem to vote on customer or service satisfaction, which can be visible to other end-users or buyers. Similarly, scoring of merchants in the system can be volunteered and provided to FIs to request for financing or loans.

### Gamification

As part of the stored value approach, at least one embodiment is envisioned that uses the accumulation and sharing of value in a gamification context whereby end-users participate in tasks or challenges to earn more value that is spendable or tradeable within the system.

This disclosure presents example embodiments and configurations for systems and methods for managing value exchange transactions within a closed commerce platform leveraging an interface that works across multiple devices, multiple channels and multiple payment rails using a smart ledger ecosystem. However, different embodiments of the system can be developed and modified without deviating from the disclosure's essence. For example, the system can be embodied with or without an app, with or without a digital wallet, and with or without fiat currency. Multiple embodiments are possible wherein all or some of the participants in the system are machines and computing devices without the need for human interface or human use. Multiple embodiments are possible and envisioned by its inventors wherein decision routines are invoked, processed, and executed via artificial intelligence, e.g., in lieu of scoring mechanisms or human-mediated dispensation or actions or transactions. And while one embodiment is a closed ecosystem, the inventors specifically envision the possibility of an open system with transparent access to ledger data not unlike the trustless environments of today's distributed ledger systems, or cryptocurrency, but with improved systems for managing value exchange and management without distributed networks or their associated cryptocurrencies, nor their processing power burdens.

Smart Ledger Management of Value Movement within the Commerce System

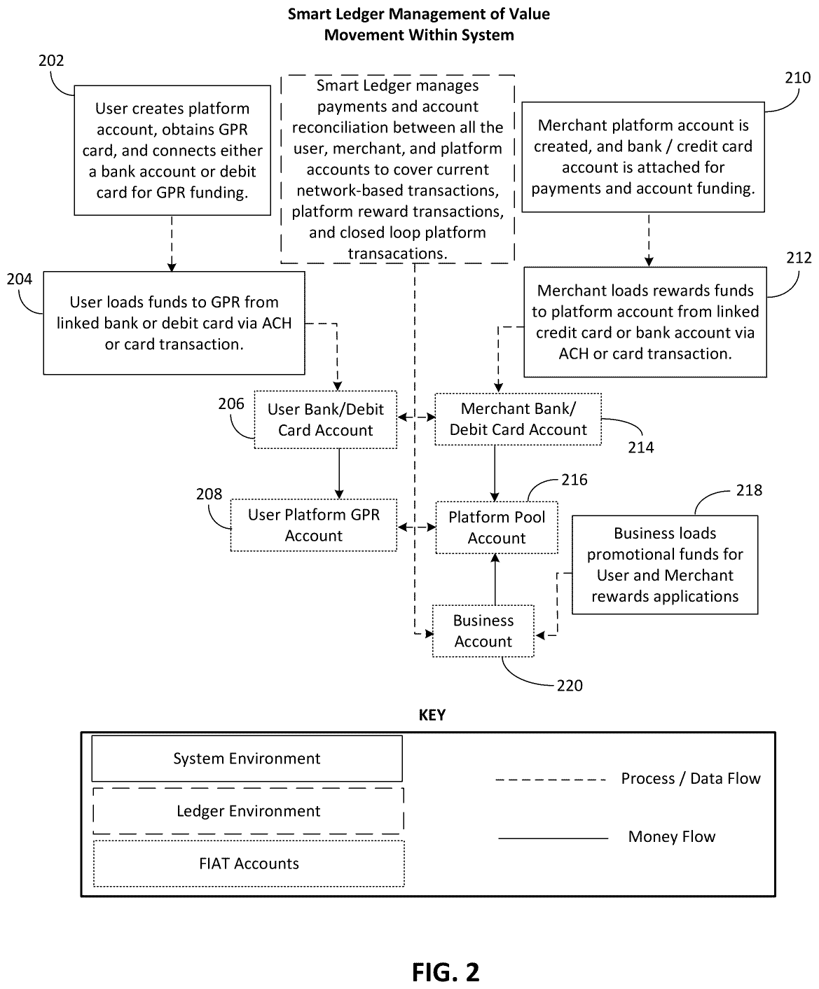

FIG. 2 is a flow diagram showing one embodiment of the intake of USD/fiat currency into a commerce system such as those described herein, and the use of a smart ledger environment (such as the ledger environment 140 shown in FIG. 1) for the movement and management of value within the commerce system prior to and including optional settlement with external traditional rails. At step 202, a user (e.g., a consumer) creates a platform account (e.g., on the central server system 125 of FIG. 1), obtains a General Purpose Reloadable Account (GPR) card, and connects either a bank account or debit card for GPR funding. At step 204, the user loads funds to their GPR from their linked bank or debit card via ACH or a card transaction. For example, this can entail transferring funds from the user's bank/debt card account 206 to the user's platform GPR account 208 (as shown in FIG. 2).

Similarly to the user, at step 210, a merchant creates a merchant platform account on the commerce system, and a bank/credit card account is attached for payments and account funding. Then, at step 212, the merchant loads rewards funds to their platform account from their linked credit card or bank account via ACH or card transaction. For example, this can entail transferring funds from the merchant's bank/debit card account 214 to the platform pool account 216. At step 218, a business can also load promotional funds for the user and merchant rewards applications to a business account 220, from which funds can be transferred to the platform pool account 216.

At step 224 smart ledger (e.g., implemented in the ledger environment 140 of FIG. 1) manages payments and account reconciliation between all the user, merchant, and platform accounts to cover current network-based transactions, platform reward transactions, and closed loop platform transactions. This includes transactions involving the user bank/debit card account 206, the user platform GPR account 208, the merchant bank/debit card account 214, the platform pool account 216, and the business account 220. The smart ledger can be implemented in accordance with the various features of ledger technologies described above.

Digital Wallet Transaction with Closed Loop Reward Earn and Spend

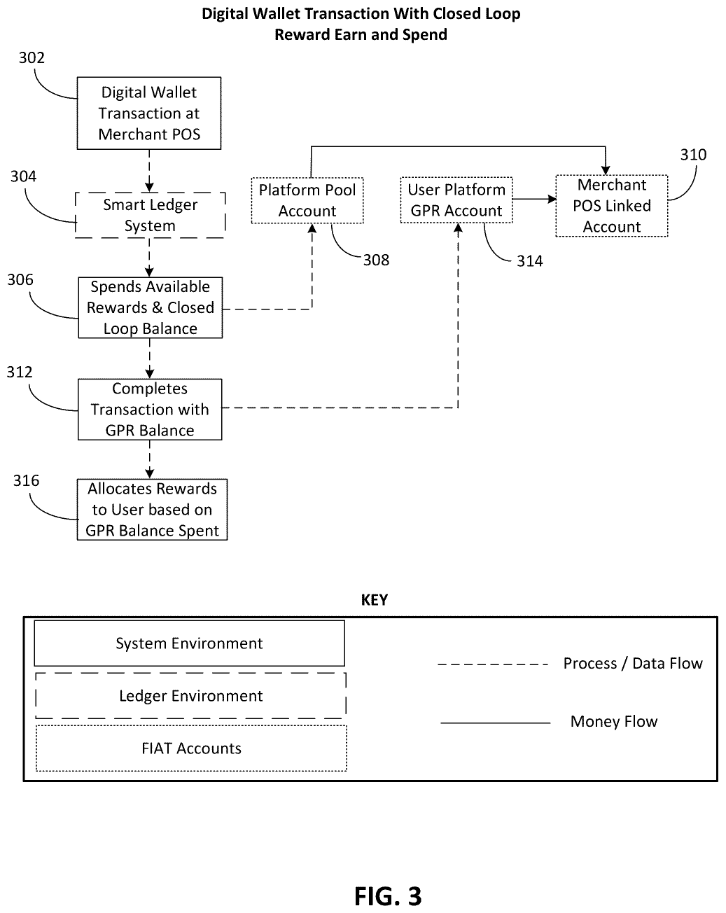

FIG. 3 is a flow diagram of one embodiment of a commerce transaction (e.g., using the commerce systems described herein) between a digital wallet user and a merchant, including optional pooling and proportioning of pre-funded cash towards an end-user's future purchase in a closed loop system where funds are intrinsically tied to a merchants' own ledger, funded by the merchant. The commerce transaction begins at step 302 with a digital wallet transaction at the merchant's point of sale (POS). At step 304, data about the transaction is fed to the smart ledger system 304 (e.g., one or more ledgers implemented in the ledger environment 140 of FIG. 1). At step 306, the smart ledger system manages the payments involved in the digital wallet transaction to spend available rewards and any available closed loop balance stored in the end-user's ledger (e.g., C1 Ledger 135 shown in FIG. 1). This can entail transferring funds from the platform pool account 308 (corresponding to, e.g., the platform pool account 216 shown in FIG. 2) to the merchant POS linked account 310 (corresponding to, e.g., the merchant bank/debit card account 214 shown in FIG. 2).

At step 312, the smart ledger system can then manage the payments involved in the digital wallet transaction to complete the transaction (e.g., any remaining portion of the transaction that has not been paid) with the end user's GPR balance. For example, this can entail transferring funds from the user platform GPR account 314 (corresponding to, e.g., the user platform GPR account 208 shown in FIG. 2) to the merchant POS linked account 310 (corresponding to, e.g., the merchant bank/debit card account 214 shown in FIG. 2). Then, at step 316, the smart ledger system can allocate rewards to the end-user based on the GPR balance spent (e.g., if the merchant has a rewards program).

### Closed Loop Transaction Flow

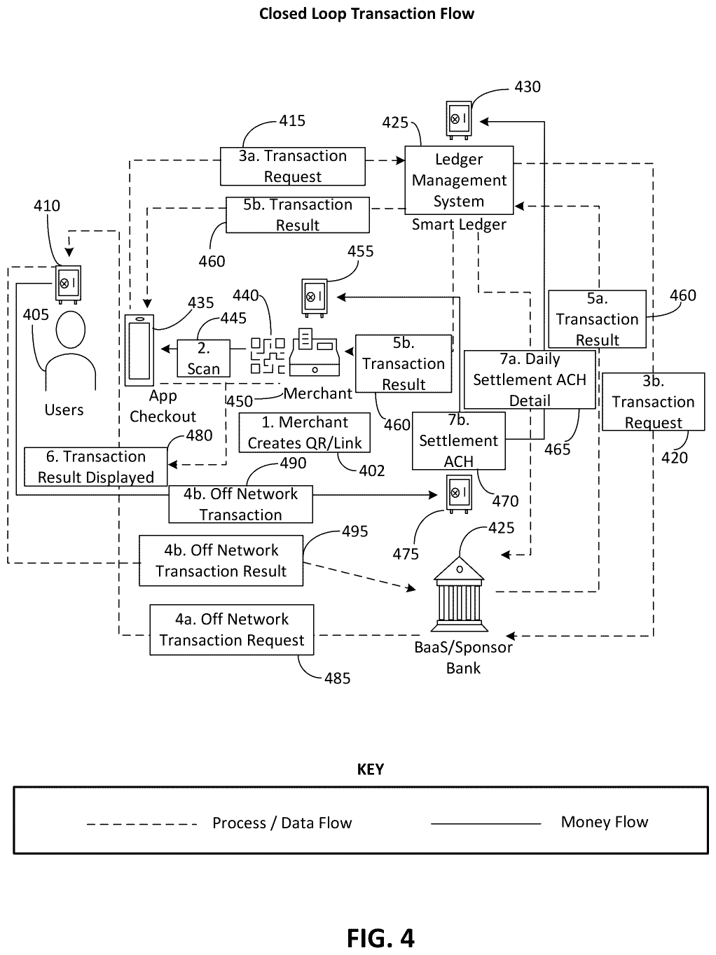

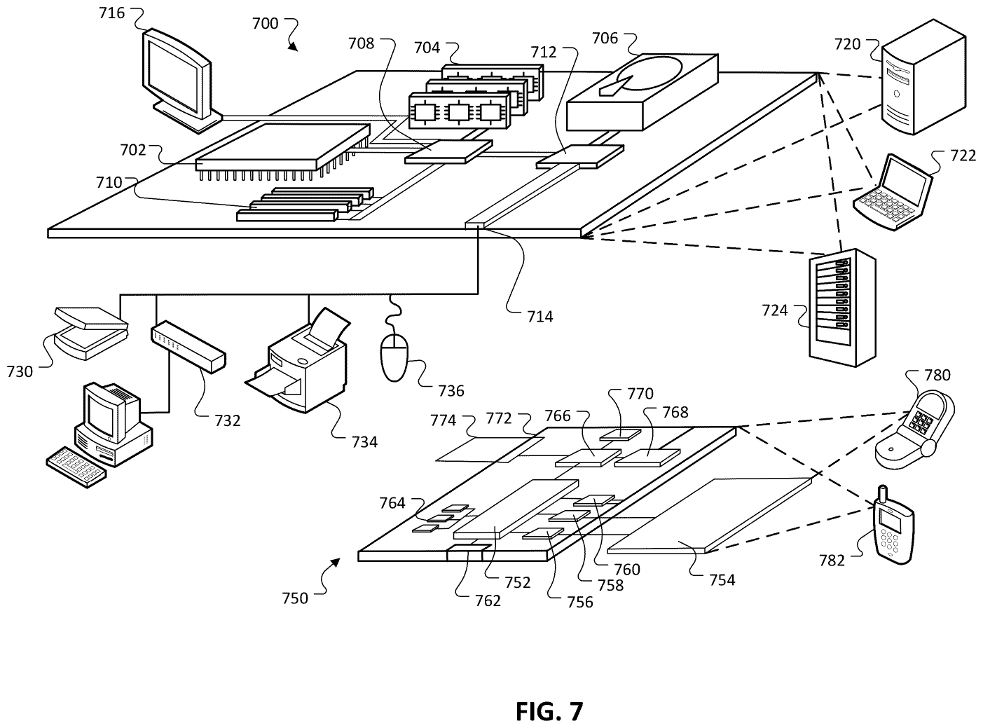

FIG. 4 is a flow diagram showing an off-network transaction request (e.g., using the commerce systems described herein) with batch electronic funds transfer between a central account and a merchant's bank via the Automated Clearing House network (ACH) for settlement and processing on behalf of the merchant. The transaction starts with a merchant 450 (e.g., an individual or business entity that sells goods or services to customers in exchange for payment) creating a QR code or link (402), which can be scanned (445) by a user 405 with the user's mobile device 435 (e.g., a device such as those described below in relation to FIG. 7). The user's mobile device 435 can run an application referred to as a “mobile checkout application,” and the QR code/link 440 can be any mechanism to provide the mobile checkout application with details about the purchase transaction or a link to a source to retrieve said details. At step 445, the user scans the QR code or link with the mobile device to start the checkout application. In other implementations, his mechanism can be changed to be any type of specific element to trigger a specific checkout.

After scanning the QR code, at step 415, a transaction request is sent from the mobile device to a ledger management system 425. This transaction request refers to an authorization request for a purchase transaction that is sent from the checkout application to the ledger management system 425. The ledger management system 425 can correspond to implementations of the smart ledger system described above and can refer to an organization and/or a corresponding software application or platform designed to manage and maintain financial ledgers efficiently (e.g., the ledger environment 140 described in relation to FIG. 1). The ledger management system 425 provides tools and functionalities to record, organize, and analyze financial transactions, ensuring accuracy, security, and compliance with accounting standards.

Next, at step 420, a transaction request is forwarded from the ledger management system 425 to a Banking-as-a-service (BaaS)/Sponsor Bank 425. The transaction request can be an authorization request for a purchase transaction sent from the ledger management system 425 to the BaaS/Sponsor Bank 425. At step 485, the Sponsor Bank 425 then sends an off-network transaction request (e.g., happening intra bank or outside of the card network payment rails) to a bank account 410 attached to the user 405 (or, more specifically, attached to the user's GPR card). In response, the bank account 410 transfers funds via an off-network transaction (490) to a bank-managed account 425. The bank-managed account 425 can be a pool account that houses funds associated to users, merchants, and a system operator (e.g., OV Loop), and the bank-managed account 425 has its transactions managed by the ledger management system 425. In addition to transferring funds, at step 495, the bank account 410 sends information about the off-network transaction result (e.g., happening intra bank or outside of the card network payment rails) to the BaaS/Sponsor Bank 425.

At step 460, the transaction result is sent to the ledger management system 425 and then to the user's mobile device 435 and the merchant 450. The transaction result that is sent can be a response from the Sponsor Bank 425 to the ledger management system 425, and then from the ledger management system 425 to the merchant's POS and the user's mobile checkout application. The response can be indicative of whether or not the transaction was approved, partially approved, declined, failed, etc. This transaction result can then be displayed, at step 480, to the user 405, for example, at the merchant's POS or on the user's mobile device 435.

At step 465, the ledger management system 425 can output settlement requests in a “Daily Settlement ACH Detail” to be processed by the BaaS/Sponsor Bank 425. The settlements include closed loop transaction funds and transaction fees. In some implementations, this step can be performed daily although it may be performed at other frequencies as well (e.g., weekly, twice daily, hourly, etc.). In response to receiving the settlement requests, at step 470, the BaaS/Sponsor Bank 425 batch processes the settlements provided in the “Daily Settlement ACH Detail.” This can entail transferring funds, as needed, to a bank account 430 associated with the system operator (e.g., OV Loop) or to a bank account 455 associated with the merchant 450. In this way, closed loop transactions can be completed, processed, and settled efficiently and accurately.

### Computing Devices and Mobile Computing Devices

The software of the commerce system and broader value exchange ecosystem 100, like program code, can be stored on computer-readable mediums and implemented on various computer systems, whether networked or not, whether tied to traditional commerce and payment systems or not, and with a centralized or decentralized approach to one ledger or a plurality of ledgers that may or may not be synchronized. FIG. 7 shows an example of a computing device 700 and a mobile computing device 750 that are employed to execute implementations of the present disclosure. For example, the computing device 700 and/or the mobile computing device 750 can be employed to execute software that provides various aspects of the functionality of the commerce system 100 described herein including functions performed by the central server system 125 and the ledger environment 140. The computing device 700 and/or the mobile computing device 750 can also correspond to the devices used by end-users, merchants, financial institutions, etc. within the value exchange ecosystem. The computing device 700 is intended to represent various forms of digital computers, such as laptops, desktops, workstations, personal digital assistants, servers, blade servers, mainframes, and other appropriate computers. The mobile computing device 750 is intended to represent various forms of mobile devices, such as personal digital assistants, cellular telephones, smart-phones, AR devices, and other similar computing devices. The components shown here, their connections and relationships, and their functions, are meant to be examples only, and are not meant to be limiting.

The computing device 700 includes a processor 702, a memory 704, a storage device 706, a high-speed interface 708, and a low-speed interface 712. In some implementations, the high-speed interface 708 connects to the memory 704 and multiple high-speed expansion ports 710. In some implementations, the low-speed interface 712 connects to a low-speed expansion port 714 and the storage device 704. Each of the processor 702, the memory 704, the storage device 706, the high-speed interface 708, the high-speed expansion ports 710, and the low-speed interface 712, are interconnected using various buses, and may be mounted on a common motherboard or in other manners as appropriate. The processor 702 can process instructions for execution within the computing device 700, including instructions stored in the memory 704 and/or on the storage device 706 to display graphical information for a graphical user interface (GUI) on an external input/output device, such as a display 716 coupled to the high-speed interface 708. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 704 stores information within the computing device 700. In some implementations, the memory 704 is a volatile memory unit or units. In some implementations, the memory 704 is a non-volatile memory unit or units. The memory 704 may also be another form of a computer-readable medium, such as a magnetic or optical disk.

The storage device 706 is capable of providing mass storage for the computing device 700. In some implementations, the storage device 706 may be or include a computer-readable medium, such as a floppy disk device, a hard disk device, an optical disk device, a tape device, a flash memory, or other similar solid-state memory device, or an array of devices, including devices in a storage area network or other configurations. Instructions can be stored in an information carrier. The instructions, when executed by one or more processing devices, such as processor 702, perform one or more methods, such as those described above. The instructions can also be stored by one or more storage devices, such as computer-readable or machine-readable mediums, such as the memory 704, the storage device 706, or memory on the processor 702.

The high-speed interface 708 manages bandwidth-intensive operations for the computing device 700, while the low-speed interface 712 manages lower bandwidth-intensive operations. Such allocation of functions is an example only. In some implementations, the high-speed interface 708 is coupled to the memory 704, the display 716 (e.g., through a graphics processor or accelerator), and to the high-speed expansion ports 710, which may accept various expansion cards. In the implementation, the low-speed interface 712 is coupled to the storage device 706 and the low-speed expansion port 714. The low-speed expansion port 714, which may include various communication ports (e.g., Universal Serial Bus (USB), Bluetooth, Ethernet, wireless Ethernet) may be coupled to one or more input/output devices. Such input/output devices may include a scanner, a printing device, or a keyboard or mouse. The input/output devices may also be coupled to the low-speed expansion port 714 through a network adapter. Such network input/output devices may include, for example, a switch or router.

The computing device 700 may be implemented in a number of different forms, as shown in FIG. 7. For example, it may be implemented as a standard server 720, or multiple times in a group of such servers. In addition, it may be implemented in a personal computer such as a laptop computer 722. It may also be implemented as part of a rack server system 724. Alternatively, components from the computing device 700 may be combined with other components in a mobile device, such as a mobile computing device 750. Each of such devices may contain one or more of the computing device 700 and the mobile computing device 750, and an entire system may be made up of multiple computing devices communicating with each other.

The mobile computing device 750 includes a processor 752; a memory 764; an input/output device, such as a display 754; a communication interface 766; and a transceiver 768; among other components. The mobile computing device 750 may also be provided with a storage device, such as a micro-drive or other device, to provide additional storage. Each of the processor 752, the memory 764, the display 754, the communication interface 766, and the transceiver 768, are interconnected using various buses, and several of the components may be mounted on a common motherboard or in other manners as appropriate. In some implementations, the mobile computing device 750 may include a camera device(s).

The processor 752 can execute instructions within the mobile computing device 750, including instructions stored in the memory 764. The processor 752 may be implemented as a chipset of chips that include separate and multiple analog and digital processors. For example, the processor 752 may be a Complex Instruction Set Computers (CISC) processor, a Reduced Instruction Set Computer (RISC) processor, or a Minimal Instruction Set Computer (MISC) processor. The processor 752 may provide, for example, for coordination of the other components of the mobile computing device 750, such as control of user interfaces (UIs), applications run by the mobile computing device 750, and/or wireless communication by the mobile computing device 750.

The processor 752 may communicate with a user through a control interface 758 and a display interface 756 coupled to the display 754. The display 754 may be, for example, a Thin-Film-Transistor Liquid Crystal Display (TFT) display, an Organic Light Emitting Diode (OLED) display, or other appropriate display technology. The display interface 756 may include appropriate circuitry for driving the display 754 to present graphical and other information to a user. The control interface 758 may receive commands from a user and convert them for submission to the processor 752. In addition, an external interface 762 may provide communication with the processor 752, so as to enable near area communication of the mobile computing device 750 with other devices. The external interface 762 may provide, for example, for wired communication in some implementations, or for wireless communication in other implementations, and multiple interfaces may also be used.

The memory 764 stores information within the mobile computing device 750. The memory 764 can be implemented as one or more of a computer-readable medium or media, a volatile memory unit or units, or a non-volatile memory unit or units. An expansion memory 774 may also be provided and connected to the mobile computing device 750 through an expansion interface 772, which may include, for example, a Single in Line Memory Module (SIMM) card interface. The expansion memory 774 may provide extra storage space for the mobile computing device 750, or may also store applications or other information for the mobile computing device 750. Specifically, the expansion memory 774 may include instructions to carry out or supplement the processes described above, and may include secure information also. Thus, for example, the expansion memory 774 may be provided as a security module for the mobile computing device 750, and may be programmed with instructions that permit secure use of the mobile computing device 750. In addition, secure applications may be provided via the SIMM cards, along with additional information, such as placing identifying information on the SIMM card in a non-hackable manner.

The memory may include, for example, flash memory and/or non-volatile random access memory (NVRAM), as discussed below. In some implementations, instructions are stored in an information carrier. The instructions, when executed by one or more processing devices, such as processor 752, perform one or more methods, such as those described above. The instructions can also be stored by one or more storage devices, such as one or more computer-readable or machine-readable mediums, such as the memory 764, the expansion memory 774, or memory on the processor 752. In some implementations, the instructions can be received in a propagated signal, such as, over the transceiver 768 or the external interface 762.

The mobile computing device 750 may communicate wirelessly through the communication interface 766, which may include digital signal processing circuitry where necessary. The communication interface 766 may provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS). Such communication may occur, for example, through the transceiver 768 using a radio frequency. In addition, short-range communication, such as using a Bluetooth or Wi-Fi, may occur. In addition, a Global Positioning System (GPS) receiver module 770 may provide additional navigation- and location-related wireless data to the mobile computing device 750, which may be used as appropriate by applications running on the mobile computing device 750.

The mobile computing device 750 may also communicate audibly using an audio codec 760, which may receive spoken information from a user and convert it to usable digital information. The audio codec 760 may likewise generate audible sound for a user, such as through a speaker, e.g., in a handset of the mobile computing device 750. Such sound may include sound from voice telephone calls, may include recorded sound (e.g., voice messages, music files, etc.) and may also include sound generated by applications operating on the mobile computing device 750.

The mobile computing device 750 may be implemented in a number of different forms, as shown in FIG. 7. For example, it may be implemented a phone device 780, a personal digital assistant 782, and a tablet device (not shown). The mobile computing device 750 may also be implemented as a component of a smart-phone, AR device, or other similar mobile device.

Computing device 700 and/or 750 can also include USB flash drives. The USB flash drives may store operating systems and other applications. The USB flash drives can include input/output components, such as a wireless transmitter or USB connector that may be inserted into a USB port of another computing device.

Other embodiments and applications not specifically described herein are also within the scope of the following claims. Various modifications and alternate embodiments are possible, including new entities in the ecosystem with roles beyond value exchange for commerce, such as the exchange of data strings, files, or records for physical goods and property. Elements of different implementations described herein may be combined to form other embodiments not specifically set forth above. Elements may be left out of the structures described herein without adversely affecting their operation. Furthermore, various separate elements may be combined into one or more individual elements to perform the functions described herein. The order of operations can be rearranged, merged, or split to provide the described features and benefits. Changes can be made in form and detail without deviating from the system's scope, which is limited only by the claims.

1. (canceled)

2. A system comprising:
one or more servers that are commonly accessible by a plurality of client system types through a single interface to make transactions via each of a plurality of payment rails,
wherein the one or more servers are configured to access a ledger environment comprising one or more ledgers that store data associated with transactions made via each of the plurality of payment rails.

3. The system of claim 2, wherein the plurality of client system types comprises at least one of a mobile computing device, a mobile web interface, a mobile application interface, a browser web interface, a special purpose client application.

4. The system of claim 2, wherein the plurality of payment rails comprises at least one open loop rail and at least one closed loop rail.

5. The system of claim 2, wherein the plurality of payment rails comprises a credit card rail, an ACH/Debit/Real Time Payment rail, an ACH/Real Time Payment rail using a pool account, a third party financing rail, and/or a ledger fulfillment rail.

6. The system of claim 2, wherein the one or more ledgers comprise at least one of an affiliate ledger, a consumer ledger, and a consumer ledger.

7. The system of claim 2, wherein the one or more ledgers comprise a consumer ledger that stores financial data corresponding to multiple kinds of value.

8. The system of claim 7, wherein the multiple kinds of value comprise platform loop cash, gift cards, one-time use cards, one-time use funds, rewards, and/or coupons.

9. The system of claim 2, wherein the one or more ledgers are real-time ledgers.

10. The system of claim 2, wherein disbursements corresponding to the transactions made via each of the plurality of payment rails are disbursed in batches.

11. The system of claim 2, wherein the single interface comprises an end-user application layer for executing payments and the movement of value.

12. The system of claim 2, wherein the single interface comprises an application or a web interface for buyers, merchants, and/or affiliates.

13. The system of claim 12, wherein the application or the web interface for buyers, merchants, and/or affiliates is layered upon an additional layer for performing processing, logic, business rules, and movement of value among the one or more ledgers.

14. The system of claim 2, wherein value can be moved among the one or more ledgers without the transactions being settled on a move-by-move basis.

15. The system of claim 14, wherein settlement of the transactions is performed upon the conversion of a digital value reflected in the one or more ledgers into a currency to be used outside of the system.

16. The system of claim 2, comprising a business rules engine configured to generate a score for a user associated with at least one of the one or more ledgers, the score being indicative of a financial trustworthiness of the user.

17. The system of claim 2, wherein the transactions made via each of the plurality of payment rails comprise a plurality of transaction types that have different processing times.

18. The system of claim 2, wherein the transactions made via each of the plurality of payment rails comprise a loan.

19. The system of claim 2, wherein the one or more ledgers are configured to transfer multiple values to multiple recipient accounts as a part of a smart contract.

20. The system of claim 2, wherein the one or more ledgers are implemented using a centralized ledger system.

21. The system of claim 2, wherein the one or more ledgers are implemented using a decentralized ledger system.
